(19) United States
(12) Patent Application Publication
(10) Pub. No.: US 2015/0083052 A1
(43) Pub. Date: Mar. 26, 2015

(54) Tooth ball

(71) Applicant: Kenneth Glaser, Bakersfield, CA (US)

(72) Inventor: Kenneth Glaser, Bakersfield, CA (US)

(21) Appl. No.: 13/987,969

(22) Filed: Sep. 20, 2013

(51) Int. Cl. A01K 11/00

(52) U.S. Cl. CPC A01K 15/026
USPC 119/709

(57) ABSTRACT

The Tooth Ball having a hollow ball with holes throughout the ball has a powdery substance that mixes with the pet's saliva which produces a paste that releases in to the attached soft spikes and cleans the pet's teeth and massages the gums leaving a very clean mouth for the pet.

### BACKGROUND OF THE INVENTION

(1) Field of the Invention

The Tooth Ball is a new design and utility functionality for a pets chew toy that cleans the teeth and massages the gums.

(2) Description of the Art Including Information Disclosed Under 37 CFR 1.97 & 1.98

The art described in the drawings of the design and utility function illustrate the unique ability of the invention to clean a pets teeth while enjoying the chew toy.

### BRIEF SUMMARY OF THE INVENTION

The Tooth Ball is a rubber ball with holes and soft spikes with a flat surface on the top of the spike that are long enough to clean the pet's teeth and massage the gums. The center is hollow which allows the powder to turn to paste with the animal's saliva and it acts a tooth brush would.

### BRIEF DESCRIPTION OF THE SEVERAL VIEWS OF THE DRAWINGS

There are 4 drawings in total that describe and illustrate the design and function of the Tooth Ball.

FIG. 1: is the Tooth Ball with the screw cap into the ball.

FIG. 2: is the Tooth Ball with the screw cap outside the ball

FIG. 3: is the Tooth Ball showing the entire tooth ball invention.

FIG. 4: is the Tooth Ball showing the top half and bottom half of the entire ball.

### DETAILED DESCRIPTION OF THE PREFERRED EMBODIMENT

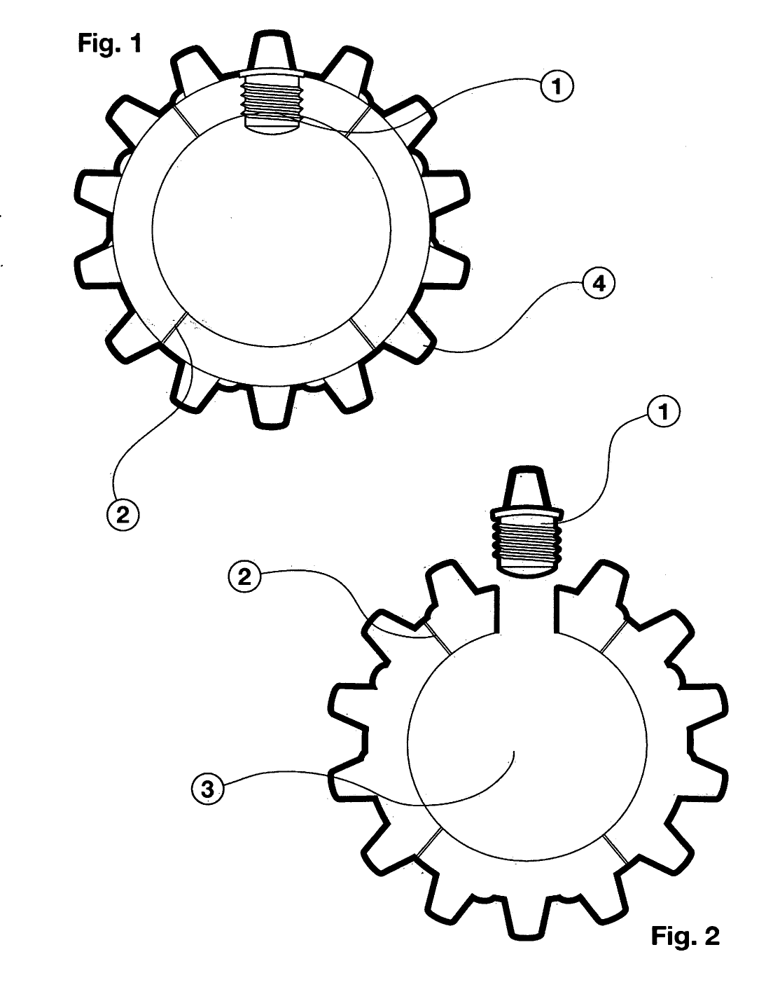

FIG. 1: In illustration #1 shows the screw cap into the ball with #2 showing the channel for the hole from the surface of the ball through the skin of the ball into the center hollow area inside the ball with #4 showing the soft spike with the flat top of the ball.

FIG. 2: In illustration #1 shows the screw cap outside the ball with #2 the channel for the hole from the surface of the ball through the skin of the ball into the #3 center hollow area inside the ball that holds the powder.

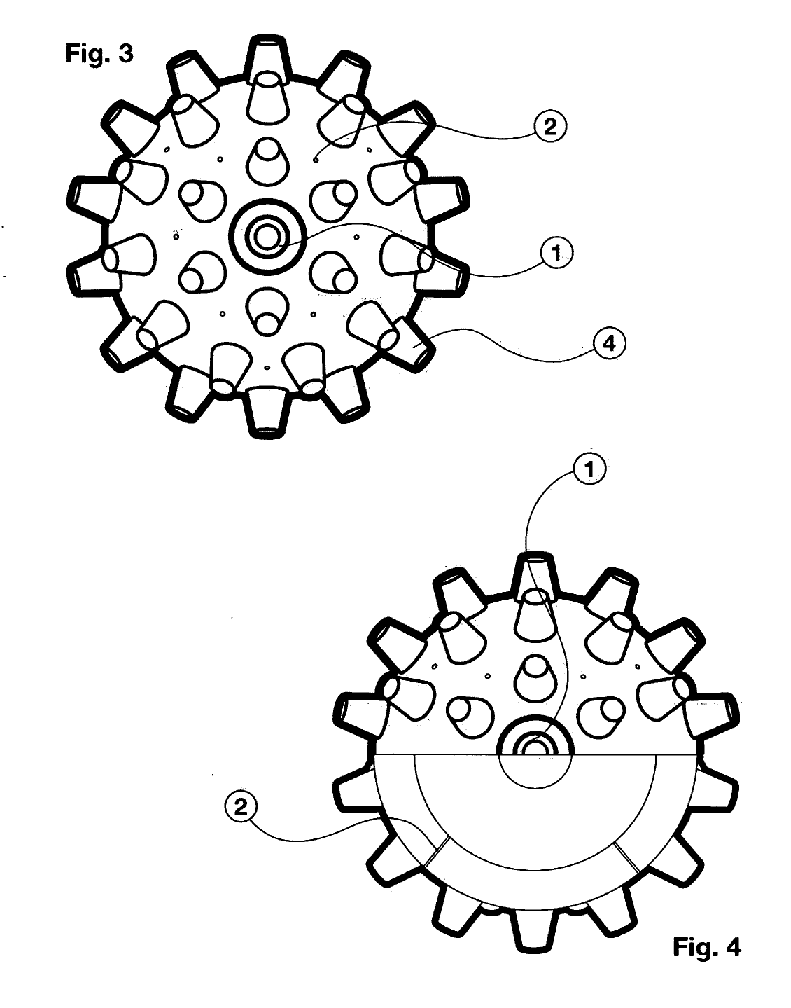

FIG. 3: In illustration #1 shows top of the screw cap inside the ball with #2 the hole on the surface of the ball with #4 the soft spike with the flat surface attached to the balls surface.

FIG. 4: In Illustration #1 shows the screw cap into the ball with #2 the channel for the hole from the surface of the ball through the skin into the hollow area of the ball.

### DETAILED DESCRIPTION OF THE INVENTION

The Tooth Ball is a new chew toy for pets that is hollow ball with holes throughout the ball. Inside the ball is a granular powder substance that mixes with the pet's saliva and becomes a paste much like a toothpaste that releases into the soft spikes with a flat surface on the top of the spike attached to the ball and while the pet is chewing the ball it is cleaning the teeth and massaging the gums. This invention is an advance in existing chew toys through the paste being produced by the ball and because of the new soft spike design to scrap the tooth and massage the gum at the same time. This a much better design which produces a positive function to safely clean the teeth without wearing the tooth like chewing a regular ball or other toy.

What is claimed is:

1: Whereas the composition of the soft spikes with the flat surface on the top of the spike attached to the tough skin of the ball acting as a tooth cleaner to scrap the teeth and massage the gums for pets.

2: Whereas the composition of claim 1, wherein the holes in the surface of the ball channel through the skin into the hollow area of the ball.

3: Whereas the composition of claim 1, wherein the granular powder substance inside the hollow area between under the skin of the ball.

4: Whereas the composition of claim 3, wherein the granular powder substance is absorbed by the saliva of the animal and turns into a paste like substance through the chewing of the ball by the animal which the paste channels back through the hole to cover the ball and spread throughout the soft spikes to clean the animals teeth.
